(19) United States
(12) Patent Application Publication
(10) Pub. No.: US 2021/0053315 A1
(43) Pub. Date: Feb. 25, 2021

(54) SANDWICH FABRIC WITH MULTI-LAYERED POCKETS

(71) Applicant: FORMOSA TAFFETA CO., LTD., Touliu (TW)

(72) Inventors: Ling Li LIN, Touliu (TW); Chia-Hao LIN, Touliu (TW); Fang-Jong LIU, Touliu (TW)

(21) Appl. No.: 16/996,370

(22) Filed: Aug. 18, 2020

(30) Foreign Application Priority Data
Aug. 19, 2019 (TW) 108129517

(51) Int. Cl. B32B 7/05; B32B 5/26; B32B 5/02; B32B 5/06

(52) U.S. Cl. CPC B32B 7/05; B32B 5/26; B32B 5/024; B32B 5/06; B32B 2307/736; B32B 2262/062; B32B 2262/0261; B32B 2262/0276; B32B 2250/20

(57) ABSTRACT

A sandwich fabric with multi-layered pockets is provided. The sandwich fabric comprises at least one first outer layer, at least one second outer layer, at least one interlayer positioned between the first outer layer and the second outer layer, at least one first sandwiched yarn positioned between its adjacent first outer layer and interlayer, and at least one second sandwiched yarn positioned between its adjacent second outer layer and interlayer, in which multiple pockets are formed by joining each interlayer with its adjacent layer, wherein joints of the first outer layer and the interlayer are adjacent to a pocket formed by the interlayer joining with a non-first outer layer; and joints of the second outer layer joining with an interlayer are adjacent to pockets formed of the interlayer joining with a non-second outer layer. Each of the sandwiched yarns consists of warp yarn, weft yarn or both warp yarn and weft yarn. The fabric can be used for various applications by adjusting properties of the outer layers and/or the sandwiched yarns.

### CROSS-REFERENCE TO RELATED APPLICATION

This application claims priority to Taiwan Application No. 108129517 filed on 19 Aug. 2019, which is hereby incorporated herein by reference.

### TECHNICAL FIELD

The present invention relates to a sandwich fabric with multi-layered pockets; in particular, to a sandwich fabric suitable for various applications.

### BACKGROUND

A conventional heat preserving garment has two layers of fabric, which are stitched together to form several fill chambers for receiving fill materials, such as goose or duck down, synthetic resin-bonded non-woven or the like. Due to such loose fill materials, air can be retained in the three-dimensional space formed between two layers of fabric, so that a user's body heat can be retained in the garment.

TW 1583838 B discloses that a pocket fabric has several pocket areas formed seamlessly by interweaving of a plurality of warps and a plurality of wefts and receiving down, which is manufactured in a cost-effective manner because no additional sewing processes are needed. However, when an outer layer and an inner layer are stitched together, irrespective of whether or not an additional sewing process is used, cold spots may be generated at the stitched seams where the down cannot be held. Therefore, body heat may escape from the pocket fabric and cold air may penetrate into the pocket fabric via the stitched seams, so such pocket fabric cannot keep the user warm as desired.

US 2017/0172240 A1 discloses a three-layered baffle construction, comprising a first outer layer, an interlayer and a second outer layer, which join together to form a plurality of interlaced baffles to address the problem relating to the inability to fill the stitched seams with down causing inadequate warmth.

However, for a conventional down jacket, after it is worn for a certain period of time, down or other fill materials may leak out through the fabric (down leakage), which makes the user uncomfortable, and the jacket may lose heat insulation over time.

### SUMMARY OF THE INVENTION

The objective of the present invention is to provide a sandwich fabric suitable for various applications.

To achieve the objective, the present invention provides a fabric, which comprises:

at least one first outer layer;

at least one second outer layer;

at least one interlayer positioned between the first outer layer and the second outer layer, each interlayer joining with an adjacent layer to form a plurality of pocket chambers, wherein joints of the first outer layer and the interlayer are adjacent to the pocket chambers formed by the interlayer joining with a non-first outer layer, and joints of the second outer layer and the interlayer are adjacent to the pocket chambers formed by the interlayer joining with a non-second outer layer;

at least one first sandwiched yarn positioned between the adjacent first outer layer and the adjacent interlayer, wherein the first sandwiched yarn consists of warp yarn, weft yarn or both warp yarn and weft yarn; and

at least one second sandwiched yarn positioned between the adjacent second outer layer and the adjacent interlayer, wherein the second sandwiched yarn consists of warp yarn, weft yarn or both warp yarn and weft yarn.

In some embodiments, the shrinkage rate of the first and second outer layers is greater than that of the first and second sandwiched yarns.

In some embodiments, the shrinkage rate of the first and second outer layers is smaller than that of the first and second sandwiched yarns.

In some embodiments, at least one of the first outer layer and the second outer layer is transparent or translucent or nontransparent.

The sandwich fabric of the present invention is suitable for various applications by adjusting the properties of the outer layers and/or the sandwiched yarns. For example, when the shrinkage rate of both of the outer layers is greater than that of at least one of the sandwiched yarns (that is, the outer layers lose more length than at least one of the sandwiched yarns do), after dyeing and finishing, the at least one sandwiched yarn twists to prop up the layers adjacent to it, so the pocket chambers of the present invention holding the sandwiched yarns achieve the same effects as down-holding pockets without requiring any additional down-filling process. On the other hand, when the shrinkage rate of both of the outer layers is less than that of at least one of the sandwiched yarns (that is, at least one of the sandwiched yarns loses more length than the outer layers do), after dyeing and finishing, the outer layers become lumpy and wrinkled but such lumpy/wrinkled outer layers are located in a restricted area due to the arrangement of the sandwiched yarns with greater shrinkage rate. The outer layers become lumpier and more wrinkled as the shrinkage rate of the outer layers increases. Since the outer layers are lumpy and wrinkled, air can be retained in the pocket chambers (especially the area between the outer layers and the sandwiched yarns) to keep the user warm. Furthermore, the sandwich fabric with a lumpy/wrinkled appearance is different from conventional down jackets with smooth appearance, so the present invention provides several appearance options. Moreover, the outer layers may be made of transparent or translucent or nontransparent materials and color, weave, texture, pattern or the like of the sandwiched yarns can be adjusted, so viewers would see the inner sandwiched yarns through the transparent/translucent or nontransparent outer layers. Hence, the sandwich fabric of the present invention exhibits a see-through effect to expand the application scope.

The detailed technology and preferred embodiments implemented for the subject invention are described in the following paragraphs for persons skilled in this field to well appreciate the features of the claimed invention.

### BRIEF DESCRIPTION OF THE DRAWINGS

FIG. 1 is a cross-sectional perspective view of the sandwich fabric with multi-layered pockets, in accordance with one embodiment of the present invention;

FIG. 2 is a cross-sectional view of the sandwich fabric with multi-layered pockets, in accordance with one embodiment of the present invention;

FIG. 3 is a cross-sectional view of the sandwich fabric with multi-layered pockets, in accordance with another embodiment of the present invention;

FIG. 4 is a cross-sectional view of the sandwich fabric with multi-layered pockets, in accordance with a further embodiment of the present invention;

FIG. 5 is a photograph showing a perspective view of the sandwich fabric of Example 1 in accordance with the present invention;

FIG. 6 is a photograph showing a cross-sectional view of the sandwich fabric of Example 1 in accordance with the present invention; and

FIG. 7 is a photograph showing a top view of a sandwiched yarn of Example 1 in accordance with the present invention.

### DETAILED DESCRIPTION OF THE DISCLOSURE

Hereinafter, some embodiments of the present invention will be described in detail. However, the present invention may also be practiced in various different forms without departing from the spirit of the present invention. The scope of the present invention shall not be considered to be limited to what is illustrated herein. In addition, unless additionally explained, the expressions “a,” “the,” or the like recited in the specification (especially in the claims) should include the singular and plural forms. Further, for the sake of definiteness, the sizes of the elements or areas in the figures may be exaggerated rather than depicted according to their actual size ratios.

Also, it should be understood that any numerical range recited herein is intended to include all sub-ranges and numbers subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10, such as 2 to 8, 3 to 6, or 4 to 9, and numbers, such as 1, 3, 4, 5, 6, 7, 8, 9 and 10.

In this context, the term “about” is used to indicate that a value measured by persons skilled in this field includes acceptable variation of error which is determined to a certain extent by how the measurement is carried out.

In this context, the term “shrinkage rate” used in the text indicates the shrinkage rate during a dyeing process, which is expressed as a percentage. For example, a material has a length of 100 cm before a dyeing process and shrinks to 10 cm after the dyeing process, so the shrinkage rate is 90%. A material has a length of 100 cm before a dyeing process and shrinks to 90 cm after the dyeing process, so the shrinkage rate is 10%.

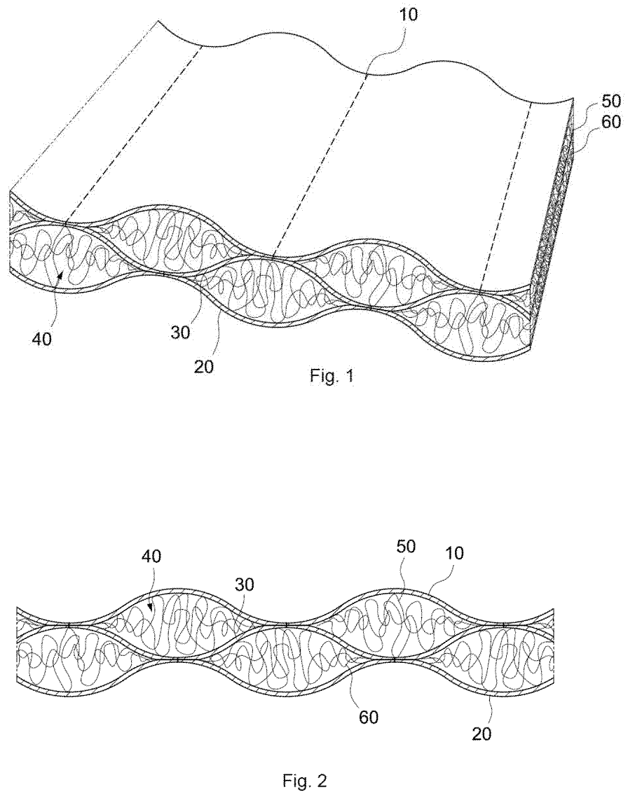

With reference to FIGS. 1 and 2, the fabric of the present invention comprises:

at least one first outer layer 10;

at least one second outer layer 20;

at least one interlayer 30 positioned between the first outer layer 10 and the second outer layer 20, each interlayer 30 joining with an adjacent layer (which is the first outer layer 10, the second outer layer 20 and/or the interlayer 30 adjacent thereto) to form a plurality of pocket chambers 40, wherein joints of the first outer layer 10 and the interlayer 30 are adjacent to the pocket chambers 40 formed by the interlayer 30 joining with a non-first outer layer (that is, a layer other than the first outer layer), and joints of the second outer layer 20 and the interlayer 30 are adjacent to the pocket chambers 40 formed by the interlayer 30 joining with a non-second outer layer (that is, a layer other than the second outer layer);

at least one first sandwiched yarn 50 positioned between the adjacent first outer layer 10 and the adjacent interlayer 30, wherein the first sandwiched yarn 50 consists of warp yarn, weft yarn or both warp yarn and weft yarn; and

at least one second sandwiched yarn 60 positioned between the adjacent second outer layer 20 and the adjacent interlayer 30, wherein the second sandwiched yarn 60 consists of warp yarn, weft yarn or both warp yarn and weft yarn.

In some embodiments, when there are two or more interlayers 30, the fabrics of the present invention may further comprise at least one third sandwiched yarn positioned between the interlayers 30.

In some embodiments, each first outer layer 10, each second outer layer 20, each interlayer 30, each first sandwiched yarn 50, each second sandwiched yarn 60 and each third sandwiched yarn independently has a shrinkage rate. When the shrinkage rate of the first outer layer 10 and/or the second outer layer 20 and/or the interlayer 30 is greater than that of the first sandwiched yarn 50 and/or the second sandwiched yarn 60 and/or the third sandwiched yarn (that is, the outer layers lose more length than the sandwiched yarns do), after dyeing and finishing processing or other thermal treatment, which is conducted after the pocket chambers 40 are formed, the first sandwiched yarn 50 and/or the second sandwiched yarn 60 and/or the third sandwiched yarn twists to prop up the layers adjacent to it. That is, at least some portions of the first sandwiched yarn 50 contact the adjacent first outer layer 10 and the adjacent interlayer 30; at least some portions of the second sandwiched yarn 60 contact the adjacent second outer layer 20 and the adjacent interlayer 30; and at least some portions of the third sandwiched yarn contact the adjacent interlayers 30, so the fabric of the present invention achieves the same effects as down-holding pockets but no additional down-filling process is required.

In one embodiment, as shown in FIGS. 1 and 2, the fabric comprises one layer of the first sandwiched yarn 50 and one layer of the second sandwiched yarn 60. However, the number of layers of the first sandwiched yarn 50, the second sandwiched yarn 60 and the third sandwiched yarn is adjustable without any limitation. Including more layers of the sandwiched yarn in the fabric improves warmth.

In one embodiment, the sandwiched yarns may have the same denier as the outer layers. In some embodiments, the sandwiched yarns may have higher denier than the outer layers. For example, the sandwiched yarns may have a denier at least about two times higher than the outer layers. The sandwiched yarns may have a denier at least about four times higher than the outer layers. The sandwiched yarns may have a denier at least about six times higher than the outer layers. The sandwiched yarns may have a denier at least about seven times higher than the outer layers. Better warmth can be achieved by increasing the denier of the sandwiched yarns.

In some embodiments, the sandwiched yarns may replace conventional down, cotton, artificial cotton and the like filled in pocket areas. In the present invention, the sandwiched yarns are preferably bulky yarns.

In the present invention, any method for joining layers/materials is possible, including, but not limited to, weaving, bonding, gluing with an adhesive, or other methods known in the art.

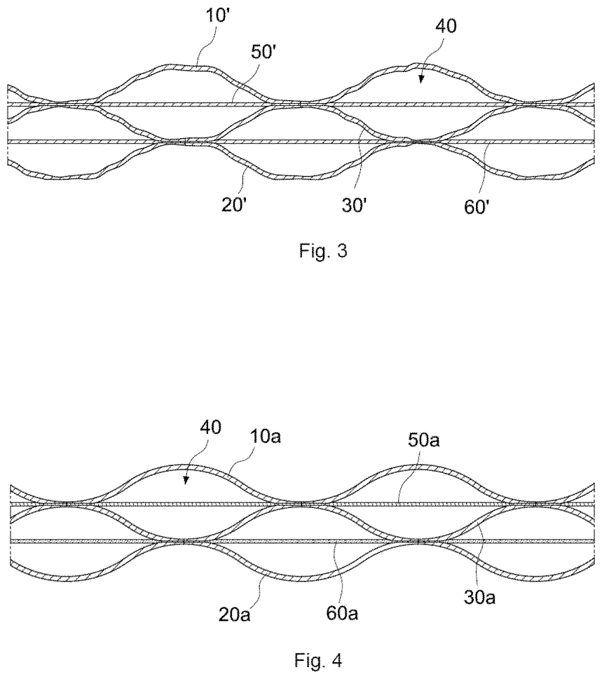

With reference to FIG. 3, in another embodiment in accordance with the present invention, the fabric comprises:

at least one first outer layer 10′;

at least one second outer layer 20′;

at least one interlayer 30′ positioned between the first outer layer 10′ and the second outer layer 20′, each interlayer 30′ joining with an adjacent layer (which is the first outer layer 10′, the second outer layer 20′ and/or the interlayer 30′ adjacent thereto) to form a plurality of pocket chambers 40, wherein joints of the first outer layer 10′ and the interlayer 30′ are adjacent to the pocket chambers 40 formed by the interlayer 30′ joining with a non-first outer layer, and joints of the second outer layer 20′ and the interlayer 30′ are adjacent to the pocket chambers 40 formed by the interlayer 30′ joining with a non-second outer layer;

at least one first sandwiched yarn 50′ positioned between the adjacent first outer layer 10′ and the adjacent interlayer 30′, wherein the first sandwiched yarn 50′ consists of warp yarn, weft yarn or both warp yarn and weft yarn; and

at least one second sandwiched yarn 60′ positioned between the adjacent second outer layer 20′ and the adjacent interlayer 30′, wherein the second sandwiched yarn 60′ consists of warp yarn, weft yarn or both warp yarn and weft yarn.

In some embodiments, when there are two or more interlayers 30′, the fabrics of the present invention may further comprise at least one third sandwiched yarn positioned between the interlayers 30′.

In some embodiments, each first outer layer 10′, each second outer layer 20′, each interlayer 30′, each first sandwiched yarn 50′, each second sandwiched yarn 60′ and each third sandwiched yarn independently has a shrinkage rate. When the shrinkage rate of the first outer layer 10′ and/or the second outer layer 20′ and/or the interlayer 30′ is less than that of the first sandwiched yarn 50′ and/or the second sandwiched yarn 60′ and/or the third sandwiched yarn (that is, the sandwiched yarns lose more length than the outer layers do), after dyeing and finishing processing or other thermal treatment, which is conducted after the pocket chambers 40 are formed, the first outer layer 10′ and/or the second outer layer 20′ and/or the interlayer 30′ become lumpy and wrinkled but such lumpy/wrinkled outer layers 10′, 20′ and/or the interlayer 30′ are located in a restricted area due to the arrangement of the first sandwiched yarn 50′ and/or the second sandwiched yarn 60′ and/or the third sandwiched yarn. Since the first outer layer 10′ and/or the second outer layer 20′ and/or the interlayer 30′ are lumpy and wrinkled, air can be retained in the pocket chambers 40 to keep the user warm. Furthermore, the sandwich fabric with a lumpy/wrinkled appearance is different from conventional down jackets with smooth appearance, so the present invention provides several appearance options.

In one embodiment, as shown in FIG. 3, the fabric comprises one first outer layer 10′ and one second outer layer 20′. However, the number of the first outer layers 10′ and/or the second outer layers 20′ is adjustable. Including more outer layers 10′, 20′ in the fabric improves warmth.

With reference to FIG. 4, in a further embodiment in accordance with the present invention, the fabric comprises:

at least one first outer layer 10a which is transparent or translucent or nontransparent;

at least one second outer layer 20a which is transparent or translucent or nontransparent;

at least one interlayer 30 positioned between the first outer layer 10a and the second outer layer 20a, each interlayer 30 joining with an adjacent layer (which is the first outer layer 10a, the second outer layer 20a and/or the interlayer 30 adjacent thereto) to form a plurality of pocket chambers 40, wherein joints of the first outer layer 10a and the interlayer 30 are adjacent to the pocket chambers 40 formed by the interlayer 30 joining with a non-first outer layer, and joints of the second outer layer 20a and the interlayer 30 are adjacent to the pocket chambers 40 formed by the interlayer 30 joining with a non-second outer layer;

at least one first sandwiched yarn 50a positioned between the adjacent first outer layer 10a and the adjacent interlayer 30, wherein the first sandwiched yarn 50 consists of warp yarn, weft yarn or both warp yarn and weft yarn; and

at least one second sandwiched yarn 60a positioned between the adjacent second outer layer 20a and the adjacent interlayer 30, wherein the second sandwiched yarn 60a consists of warp yarn, weft yarn or both warp yarn and weft yarn.

In some embodiments, the outer layers are made of transparent or translucent or nontransparent materials, which may be bright or semi dull polyester, polyamide, polyimide or the like.

In some embodiments, when there are two or more interlayers 30, the fabrics of the present invention may further comprise at least one third sandwiched yarn positioned between the interlayers 30.

In some embodiments, the properties (in particular the shrinkage rate) of materials of the first sandwiched yarn 50a and/or second sandwiched yarn 60a and/or third sandwiched yarn may be identical to or different from those of the first outer layer 10a and the second outer layer 20a.

The sandwiched yarns 50a, 60a may use dyed polyester or polyamide yarn, cationic dyeable polyester, regenerated polyamide fiber (including but not limited to rayon) or natural fiber (including but not limited to cotton, wool, silk) or the like as a raw material.

In some embodiments, in accordance with the present invention, the first sandwiched yarn 50a and/or the second sandwiched yarn 60a may have various colors or materials different from the outer layers, so that the color or patterns of the first sandwiched yarn 50a and/or the second sandwiched yarn 60a exhibit through the transparent outer layers so as to create special visual effects.

In one embodiment, paillettes, (colored) wool balls/plastic balls or other accessories are placed between the first outer layer 10a and the first sandwiched yarn 50a and/or the second outer layer 20a and the second sandwiched yarn 60a, so that such sandwich fabric exhibits various visual effects.

The disclosed inventions are not intended to be limited to the embodiments shown above.

With respect to the sandwich fabric of the present invention, the first outer layer is woven by the first warp and the first weft; the second outer layer is woven by the second warp and the second weft; each interlayer is woven by the third warp and the third weft, wherein the warp density and the weft density may be independently in a range between about 100/inch and about 1400/inch, preferably in a range between about 200/inch and about 1200/inch, more preferably in a range between about 300/inch and about 1000/inch.

In some embodiments, the warp and weft of each of the first outer layer, the second outer layer and the interlayer may have the same shrinkage rate or different shrinkage rates.

In some embodiments, each of the first, second and third sandwiched yarns may be made of warp (yarn) only, weft (yarn) only or both warp (yarn) and weft (yarn). These sandwiched yarns may be general yarn (including but not limited to synthetic cellulose, regenerated cellulose, natural cellulose and the like) or synthetic cellulose, regenerated cellulose, natural cellulose and the like with functional properties (including but not limited to far infrared heating yarn, moisture-absorbing and heat-radiating yarn, electrically conductive yarn, thermally conductive yarn, antistatic yarn or the like. The warp density and the weft density may be independently in a range between about 100/inch and about 1400/inch, preferably in a range between about 200/inch and about 1200/inch, more preferably in a range between about 300/inch and about 1000/inch.

The disclosed inventions are not intended to be limited to the embodiments shown above.

The sandwich fabric of the present invention may further comprise the following embodiments.

In one embodiment, each sandwiched yarn may be made of warp yarn or weft yarn.

In another embodiment, each sandwiched yarn may be made of warp yarn, weft yarn or both nonwoven warp yarn and weft yarn.

In yet another embodiment, each sandwiched yarn may be made of both nonwoven warp yarn and weft yarn.

In a further embodiment, each sandwiched yarn may be made of both woven warp yarn and weft yarn. In this embodiment, it is preferred that the shrinkage rate of the first and second outer layers is different from that of the first and second sandwiched yarns.

In a further embodiment, each sandwiched yarn may be made of both of woven warp yarn and weft yarn. In this embodiment, the shrinkage rate of the first sandwiched yarn may be identical to or different from that of the second sandwiched yarn.

In a further embodiment, each sandwiched yarn may be made of both of woven warp yarn and weft yarn. In this embodiment, when the shrinkage rate of the warp yarn is different from that of the weft yarn, the difference may be from about 1% to about 85%, preferably from about 5% to about 70%, and more preferably from about 10% to about 60%.

The sandwich fabric of the present invention may cover one or more embodiments mentioned above or any combination of these embodiments as desired.

When the shrinkage rate of the first and second outer layers is different from that of the first and/or second and/or third sandwiched yarns, the difference may be from about 5% to about 70%, preferably from about 20% to about 60%, and more preferably from about 30% to about 50%.

In some embodiments, the materials with high shrinkage rate indicate materials with shrinkage rate from about 5% to about 70%, preferably from about 20% to about 60%, and more preferably from about 30% to about 50%, which comprise mechanical stretch fabric, such as polyester with high crimp rigidity (CR), polyamide, styrene-butadiene-styrene copolymer (SBS), polybutylene terephthalate (PBT), polytrimethylene terephthalate (PTT) and the like; and Spandex stretch fabric, such as Lycra®, Roica® and the like.

In some embodiments, the materials with low shrinkage rate indicate materials with shrinkage rate from about 0% to about 20%, preferably from about 0% to about 15%, and more preferably from about 0% to about 10%, which comprise synthetic fiber (including but not limited to polyamide fiber, polyester fiber or polypropylene fiber, or other hydrophilic fibers or hydrophobic fibers), regenerated fiber (including but not limited to rayon) or natural fiber (including but not limited to cotton, wool, silk) and the like as raw materials.

In some embodiments, the interlayer may be made of synthetic fiber (including but not limited to polyamide fiber, polyester fiber, elastic fiber or polypropylene fiber, or other hydrophilic fibers or hydrophobic fibers), regenerated fiber (including but not limited to rayon) or natural fiber (including but not limited to cotton, wool, silk) and the like as raw materials.

In some embodiments, thickness of each of the first outer layer, the interlayer and the second outer layer may be independently from about 0.01 mm to about 5 mm, preferably from about 0.05 mm to about 1 mm, more preferably from about 0.05 mm to about 0.8 mm, and most preferably from about 0.08 mm to about 0.5 mm.

In some embodiments, deniers of each of the first outer layer, the interlayer and the second outer layer may be independently from about 5 denier (D) to about 1200D, preferably from about 15D to about 1000D, more preferably from about 30D to about 1000D, and most preferably from about 75D to about 600D.

In some embodiments, thread count of each of the first outer layer, the interlayer and the second outer layer may be independently from about 5 to about 200, preferably from about 10 to about 180, more preferably from about 16 to about 150, and most preferably from about 30 to about 120.

In some embodiments, the pocket chambers may be substantially not filled with anything, including down, cotton or the like. Alternatively, to increase warmth or to make the fabric loose, the pocket chambers may be still filled with fill materials. It is preferred that the pocket chambers, which are not adjacent to the outer layers, are filled with down, cotton or the like to avoid leakage of down, cotton or the like through the outer layers. For example, when there are a plurality of interlayers, the pocket chambers, which are not adjacent to the outer layers, are filled with fill materials, so that down, cotton or the like are encompassed by the interlayers. In this way, down, cotton or the like would not leak out through the fabric (down leakage).

In some embodiments, the overall thickness of the sandwich fabric may be from about 1 mm to about 100 mm, preferably from about 1 mm to about 50 mm, more preferably from about 1 mm to about 30 mm, most preferably from about 1 mm to about 20 mm.

In some embodiments, the sandwich fabric may be processed to form garments, sleeping bags, bed clothes or the like.

### EXAMPLES

### Example 1 (Shrinkage Rate of the Outer Layers Greater than that of the Sandwiched Yarns)

The sandwich fabric of this example comprises a first outer layer, a second outer layer and an interlayer, which are made of about 75 deniers of polyethylene terephthalate (PET), a first sandwiched yarn positioned between the first outer layer and the interlayer, which is made of about 300 deniers of PET, and a second sandwiched yarn positioned between the second outer layer and the interlayer, which is made of about 300 deniers of PET. The total thickness of the sandwich fabric is about 1.85 mm Each of the first outer layer, the second outer layer and the interlayer has a thickness of about 0.35 mm and a shrinkage rate of about 35%. Each of the first and second sandwiched yarns has a thickness of about 0.4 mm and a shrinkage rate of about 3%.

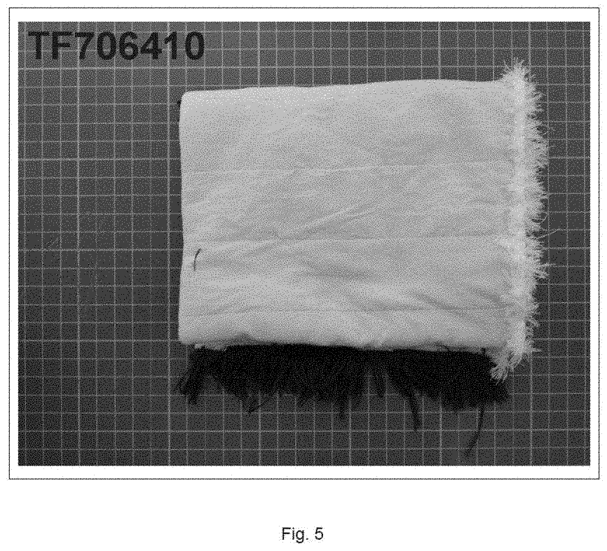

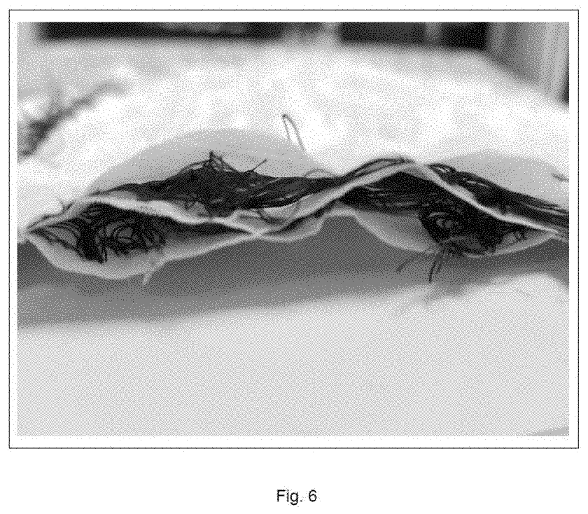

FIGS. 5 to 7 are photographs showing a perspective view and a cross-sectional view of the sandwich fabric and a top view of a sandwiched yarn of Example 1, respectively. It can be observed from these photographs that, because the shrinkage rate of the outer layer and the interlayer is greater than that of the sandwiched layer, the loose sandwiched yarn twists in the pocket chambers between the outer layer and the interlayer to prop up these layers, so that the sandwiched yarns may be used to replace conventional down, cotton, artificial cotton and the like filled in pocket areas to create warmth.

Thermal resistance was measured to determine whether the sandwich fabric of the present invention has sufficient thermal resistance for protection from the cold. In general, as the sandwich fabric has higher thermal resistance, it provides more protection against cold. The test results of the thermal resistance of the sandwich fabric of Example 1 are shown in Table 1.

TABLE 1

| Test items | Results | Test method |
|---|---|---|
| thermal resistance (clo) | 0.9074 | ISO 11092: 2014 |
| | | 20° C. · 65% R.H. |
| thermal resistance (m · K/W) | 0.140 | ISO 11092: 2014 |
| | | 20° C. · 65% R.H. |

The thermal resistances of normal clothes were shown in Table 2.

TABLE 2

| Tested object | Thermal resistance (clo) |
|---|---|
| jacket | 0.6 |
| down jacket | 0.55 |
| cotton-felt coat | 0.55 |
| thick sweater | 0.35 |
| normal sweater | 0.28 |
| normal jacket | 0.2 |
| cotton-felt pants | 0.35 |
| cotton-felt vest | 0.2 |

(Source: IS09920-1995 Annex B)

It appears that the sandwich fabric of the present invention has significantly improved thermal resistance (clo) relative to normal clothes.

### Example 2 (Shrinkage Rate of the Outer Layers Smaller than that of the Sandwiched Yarns)

The sandwich fabric of Example 2 has the same structure as that of Example 1 and differs from Example 1 in that the sandwiched yarns used in Example 2 are about 75 deniers.

### Example 3 (Outer Layers Made of Transparent/Translucent Materials)

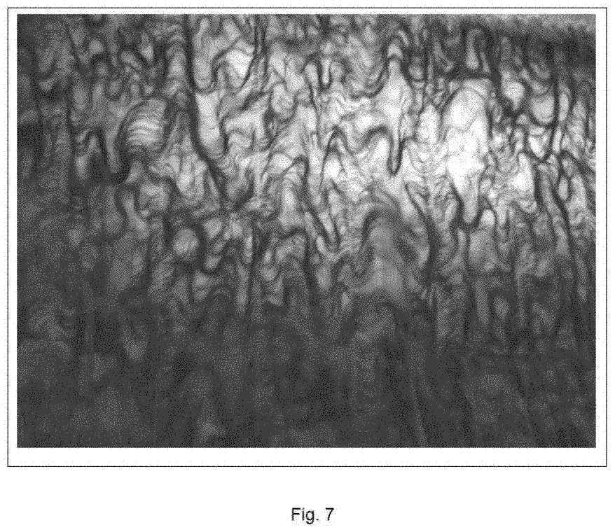

The sandwich fabric of Example 3 is similar to that of Example 1 and differs from Example 1 in that the sandwich fabric of Example 3 comprises two outer layers made of translucent polyester having about 75 deniers and sandwiched yarns made of black polyester yarn having about 75 deniers, so that viewers would see curly black sandwiched yarns through the outer layers as shown in FIG. 7.

The above disclosure is related to the detailed technical contents and inventive features thereof. Persons skilled in this field may proceed with a variety of modifications and replacements based on the disclosures and suggestions of the invention as described without departing from the characteristics thereof. Nevertheless, although such modifications and replacements are not fully disclosed in the above descriptions, they are substantially covered in the following claims as appended.

1.-20. (canceled)

21. A fabric, comprising:
at least one first outer layer;
at least one second outer layer;
at least one interlayer positioned between the first outer layer and the second outer layer, each interlayer joining with an adjacent layer to form a plurality of pocket chambers, wherein joints of the first outer layer and the interlayer are adjacent to the pocket chambers formed by the interlayer joining with a non-first outer layer, and joints of the second outer layer and the interlayer are adjacent to the pocket chambers formed by the interlayer joining with a non-second outer layer;
at least one first sandwiched yarn positioned between the adjacent first outer layer and the adjacent interlayer, wherein the first sandwiched yarn consists of warp yarn, weft yarn or both warp yarn and weft yarn; and
at least one second sandwiched yarn positioned between the adjacent second outer layer and the adjacent interlayer, wherein the second sandwiched yarn consists of warp yarn, weft yarn or both warp yarn and weft yarn.

22. The fabric according to claim 21, wherein the first outer layer has a shrinkage rate greater than the shrinkage rate of the first and second sandwiched yarns; and the second outer layer has a shrinkage rate greater than the shrinkage rate of the first and second sandwiched yarns.

23. The fabric according to claim 21, wherein the first outer layer has a shrinkage rate smaller than the shrinkage rate of the first and second sandwiched yarns; and the second outer layer has a shrinkage rate smaller than the shrinkage rate of the first and second sandwiched yarns.

24. The fabric according to claim 22, wherein the difference between the shrinkage rate of the outer layers and that of the sandwiched yarns is from about 5% to about 70%.

25. The fabric according to claim 23, wherein the difference between the shrinkage rate of the outer layers and that of the sandwiched yarns is from about 5% to about 70%.

26. The fabric according to claim 22, wherein the shrinkage rate of the first and second outer layers is from about 5% to about 70%; and the shrinkage rate of the first and second sandwiched yarns is from about 0% to about 20%.

27. The fabric according to claim 23, wherein the shrinkage rate of the first and second sandwiched yarns is from about 5% to about 70%; and the shrinkage rate of the first and second outer layers is from about 0% to about 20%.

28. The fabric according to claim 22, wherein the sandwiched yarns may have a denier at least two times higher than the outer layers.

29. The fabric according to claim 21, wherein at least one of the first outer layer and the second outer layer is transparent or translucent or nontransparent.

30. The fabric according to claim 22, wherein at least one of the first outer layer and the second outer layer is transparent or translucent or nontransparent.

31. The fabric according to claim 23, wherein at least one of the first outer layer and the second outer layer is transparent or translucent or nontransparent.

32. The fabric according to claim 29, wherein the first and second outer layers have a shrinkage rate identical to the shrinkage rate of the first and second sandwiched yarns.

33. The fabric according to claim 21, wherein the warp density and the weft density of the sandwiched yarns are independently in a range between about 100/inch and about 1400/inch.

34. The fabric according to claim 21, wherein the denier of each of the first outer layer, the interlayer and the second outer layer is independently from about 5D to about 1200D.

35. The fabric according to claim 21, wherein the thread count of each of the first outer layer, the interlayer and the second outer layer is independently from about 5 to about 200.

36. The fabric according to claim 21, wherein the first outer layer is woven by the first warp and the first weft; the second outer layer is woven by the second warp and the second weft; each interlayer is woven by the third warp and the third weft, wherein the warp density and the weft density of the first, second and third warp and weft are independently in a range between about 100/inch and about 1400/inch.

37. The fabric according to claim 21, wherein the thickness of each of the first outer layer, the interlayer and the second outer layer is independently from about 0.01 mm to about 5 mm.

38. The fabric according to claim 21, wherein the overall thickness of the fabric is from about 1 mm to about 100 mm.

39. The fabric according to claim 21, further comprising at least one third sandwiched yarn positioned between these interlayers when there are two or more interlayers.

40. The fabric according to claim 21, wherein the shrinkage rate of the warp yarn of the sandwiched yarn is different from that of the weft yarn and the difference is from about 1% to about 85%.
